(19) United States
(12) Patent Application Publication
(10) Pub. No.: US 2026/0095457 A1
(43) Pub. Date: Apr. 2, 2026

(54) Systems and Methods for Automatic Rule Generation for Micro-Segmentation

(71) Applicant: CSP Inc., Lowell, MA (US)

(72) Inventors: Henry Tumblin, Castine, ME (US); Gary Southwell, Leander, TX (US)

(21) Appl. No.: 18/904,064

(22) Filed: Oct. 1, 2024

(51) Int. Cl. H04L 9/40

(52) U.S. Cl. CPC H04L 63/104

(57) ABSTRACT

The various implementations described herein include methods and devices for automatically generating network rules. In one aspect, a method includes receiving telemetry data from devices belonging to a device group within a network, and automatically generating rules for the device group based on the telemetry data. The rules specify which connections are allowed or blocked for the devices of the device group. The method also includes updating network rules for the device group based on the newly generated rules for the first device group and transmitting the updated network rules for the device group to the devices of the device group. Also disclosed is a method of transmitting telemetry data from a device belonging to the device group and enforcing network rules for devices belonging to the device group.

### TECHNICAL FIELD

The disclosed implementations relate generally to cybersecurity and more specifically to systems and methods of using automatic rule generation for micro-segmentation.

### BACKGROUND

Cybersecurity, the practice of protecting systems and networks from digital attacks, is increasingly important in the digital age. Digital attacks are becoming increasingly sophisticated and conventional endpoint detection and response (EDR) solutions are losing their effectiveness. One method of improving security is the practice of micro-segmentation, which involves dividing a network into segments and applying different security controls or settings to the various segments. Current implementations of micro-segmentation require additional hardware and configuration (e.g., security settings for each segment). This can be disruptive to install into existing networks and results in a costly investment that is also expensive to configure and maintain. For example, conventional micro-segmentation implementations require additional hardware, specialized hardware, and/or specialized configuration to implement full micro-segmentation capabilities through virtual local area networks (VLANs) within a firewall, devices need to be individually configured within each VLAN, and each VLAN needs to be configured for each device to control connections to and from each device. This requires a high-level of detail to be maintained by a network's administrator, and any changes need to be manually configured by the administrator, either to configure a new device within the VLAN and/or to change rules in the firewall. Thus, conventional implementations of micro-segmentation trade increased security for higher maintenance.

### SUMMARY

A zero trust (ZT) system of the present disclosure enhances security for computing devices in a network using micro-segmentation. By implementing security controls for a device at the device level, instead of conventional methods of implementing security controls from a firewall, the need for special device-specific rules at the firewall is eliminated. Additionally, firewall additions or hardware upgrades, which may be required to accommodate additional rules, can be avoided, thereby increasing the speed at which new devices can be deployed within a network. Unlike conventional approaches to micro-segmentation, the present disclosure describes systems and methods for micro-segmentation that utilizes device groups within a network. Each device on the network is assigned to a device group, and network rules for a device group are used to instruct a zero trust (ZT) agent (installed on the device) on which connections are allowed or prohibited for each device within the device group. The disclosed system tracks traffic (e.g., connections) to and from each device on a network, and automatically generates rules for specific device groups (e.g., segments) within the network based on the device's connection history. This eliminates the tedious, complicated, and error-prone nature of manually developing network rules and provides low-maintenance and up-to-date security settings for all devices within the network.

In accordance with some implementations, a method includes receiving telemetry data from a device group. The device group includes one or more devices, and the one or more devices of the device group are part of a network. The method also includes automatically generating one or more first rules for the device group based on the telemetry data. The one or more first rules specify which connections are allowed or blocked for the one or more devices of the device group. The method also includes updating network rules for the device group based on the one or more first rules for the device group. The network rules for the device group specify which connections are allowed or blocked for devices connected to the network. The method further includes transmitting the updated network rules for the device group to the one or more devices of the device group.

In accordance with some implementations, a method is performed at a computing device that is part of a network. The method includes collecting telemetry data for the computing device. The computing device is part of a device group. The method also includes transmitting the telemetry data to a trust center that is in communication with the computing device and receiving updated network rules for the device group from the trust center. The updated network rules for the device group have been automatically generated at a trust store, the updated network rules for the device group have been generated based at least in part on the telemetry data, and the updated network rules for the device group specify which connections are allowed or blocked for devices that are part of the device group. The method further includes updating allowed and blocked (e.g., disabled) connections to and from the computing device based on the updated network rules for the device group.

In some implementations, a computing device includes one or more processors, memory, a display, and one or more programs stored in the memory. The programs are configured for execution by the one or more processors. The one or more programs include instructions for performing any of the methods described herein.

In some implementations, a non-transitory computer-readable storage medium stores one or more programs configured for execution by a computing device having one or more processors, memory, and a display. The one or more programs include instructions for performing any of the methods described herein.

In various circumstances, the systems and methods of the present disclosure have the following advantages over conventional security systems and micro-segmentation approaches. First, in accordance with some implementations, the disclosed systems and methods provide cost-effective and low maintenance strategies for implementing micro-segmentation. The disclosed systems and methods do not require installation of additional hardware or specialized hardware to deploy micro-segmentation, and automatically generate rules for each device group (e.g., segment) within the network, eliminating the need for constant manual configuration from an administrator.

Thus, methods and systems are disclosed for automatic rule generation for micro-segmentation. Such methods and systems may complement or replace conventional methods and systems of implementing micro-segmentation for network security.

### BRIEF DESCRIPTION OF THE DRAWINGS

For a better understanding of the aforementioned systems and methods, as well as additional systems and methods that provide automatic rule generation capabilities for deploying micro-segmentation at a network, reference should be made to the Description of Implementations below, in conjunction with the following drawings in which like reference numerals refer to corresponding parts throughout the figures.

FIG. 1 illustrates an example network architecture in accordance with some implementations.

FIG. 2 is a block diagram of an example computing device in accordance with some implementations.

FIG. 3 is a block diagram of an example server in accordance with some implementations.

FIG. 4 illustrates a process of automatic rule generation and rule implementation in accordance with some implementations.

FIGS. 5A and 5B provide a flowchart of a method for automatically generating network rules in accordance with some implementations.

FIGS. 6A and 6B provide a flowchart of a method performed at a computing system that is part of a network in accordance with some implementations.

Reference will now be made to implementations, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DESCRIPTION OF IMPLEMENTATIONS

A zero trust (ZT) system of the present disclosure provides low-maintenance micro-segmentation that automatically generates rules and provides on-device deployment of security controls. In accordance with some implementations, the zero trust system includes a trust agent installed at a computing device (also sometimes called an endpoint) that is part of a device group (also referred to as a segment or micro-segment) within a network. The trust agent monitors and intercepts memory operations on the computing device, tracks connections to and from the computing device, and collects telemetry data to be analyzed by a trust store associated with the computing device's network. The trust agent also implements the security policy for the computing device based on network rules for the device group that the computing device belongs to, including validating applications, processes, and functions before allowing them to run on the computing device. Invalid applications, processes, and functions are blocked or monitored by the trust agent (e.g., depending on the security policy for the device group of the computing device). In some implementations, the network rules for a device group within the network are automatically generated by the trust store, and the network rules for a device group are generated based on the telemetry data received from computing devices that belong to the device group. The ZT system may complement or replace conventional network security solutions that handle known bad operating systems and application processes and seek to enhance security using micro-segmentation.

In some implementations, a “network rule” is a rule that has been approved (e.g., by an administrator). In some implementations, these are referred to as “static rules” and can only be removed by the administrator once set. This helps to prevent accidental override.

In some implementations, the algorithm is to first reduce the data set by removing duplicate telemetry data, then add in any static rules (e.g., to exclude ranges of IP addresses or ports, or to include all IP addresses in the local subnet). In some implementations, the method then converts the telemetry into BPF (e.g., Berkeley Packet Filter, which permits computer network packets to be captured and filtered at the operating system level). If the device group is set to auto-accept updates, the rules will be sent to the corresponding devices for the device group. If the administrator decides to keep a generated rule across updates, the administrator tags the rule as static.

New devices are initially placed into the default device group. The site administrator can then opt to move a device from the default device group into a different group (e.g., “Production Line #1”). Each device group has its own policies. The network rules are one of the protection policies associated with each device group, similar to how countermeasures are associated with a device group.

Each device group can include a wide variety of security parameters in addition to countermeasure policies and network policies. Some implementations include one or more of the following protection policies/parameters:
Allow Local Notifications
Allow Admin Access
Allow_Agent_Logging
Allow_Agent_Unload
Allow_Local_Management
Allow_Template_Entries
Allow_TrustID_Create
Allow_Updates
Auto Trust Installers
CommSvc_Connect_Timeout
CommSvc_Oplog_Count
CommSvc_Oplog_Interval
CommSvc_Process_Scan_Interval
CommSvc_Upload_Count
CommSvc_Upload_Interval
Delete Activity Logs on Upload
Delete Alerts on Upload
Delete Operational Logs on Upload
Device_Inactivity_Timeout
Device_Time_Drift
Enable Local Device Console
Enable Local Device Console Debug
Enable Process Scan
Enable_File_Monitor
FileMonitor_Create_TrustIDs
FileMonitor_Rescan_Interval
FileMonitor_Scan_OnBoot
Heartbeat_Interval
Install AZT Agent
Install Network AZT Agent
Maximum Pending Activity Logs
Maximum Pending Alerts
Maximum Pending Operational Logs
Publisher Trust
Report_To_Trustcenter
Standalone Mode
Update Service Interval
Update Service Timeout
Upload Activity Logs
Upload Alerts
Upload Operational Logs

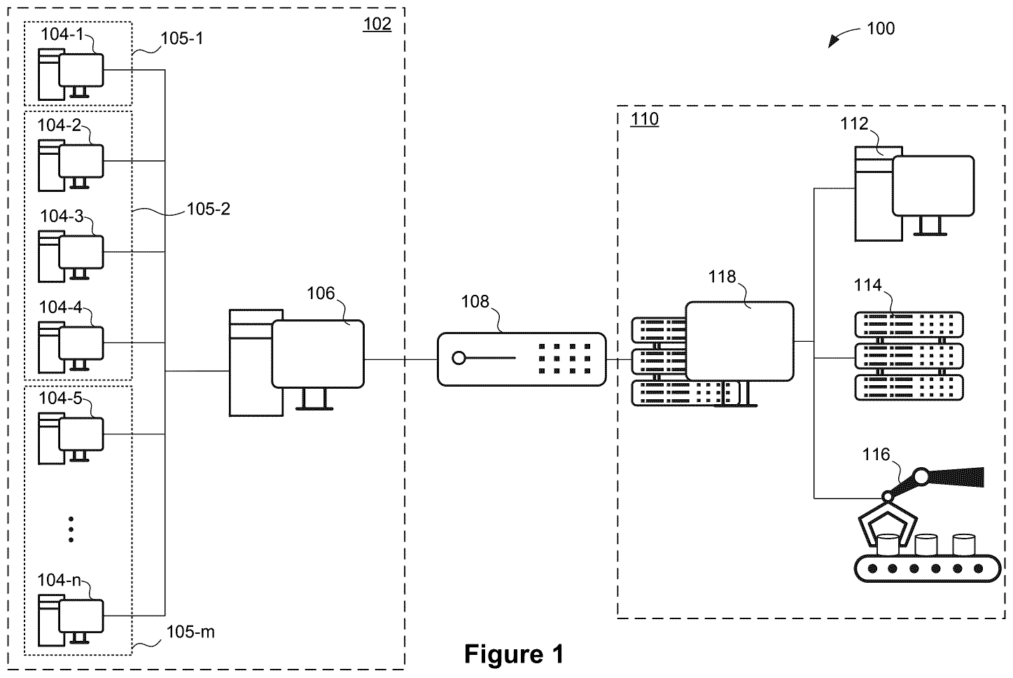

FIG. 1 illustrates a network architecture 100 in accordance with some implementations. The network architecture 100 includes an information technology (IT) portion 102 that is communicatively coupled to an operational technology (OT) portion 110 via a gateway device 108. The IT portion 102 includes user devices 104 (104-1, 104-2, . . . , and 104-n) and a hub device 106. In some implementations, each user device 104 includes a trust agent. In some implementations, the hub device 106 includes a trust store or trust center. In some implementations, the hub device 106 includes administrative software to manage trust binaries and/or trust policies of the user devices 104. The OT portion 110 includes a supervisory terminal 118, a user terminal 112, a server 114, and equipment 116. In some implementations, the supervisory terminal 118, the user terminal 112, the server 114, and the equipment 116 each includes a trust agent. In some implementations, the supervisory terminal 118 includes software to manage trust binaries and/or trust policies of the user terminal 112, the server 114, and the equipment 116. In some implementations, the gateway device 108 provides a demilitarized zone (DMZ) between the IT portion 102 and the OT portion 110. In some implementations, the gateway device 108 includes a trust center or trust store for the IT portion 102 and/or the OT portion 110. In some implementations, the gateway device 108 provides network access to an application store for the IT portion 102 and/or the OT portion 110. In some implementations, the network architecture 100 implements a Purdue Enterprise Reference Architecture (PERA) model. In reference to the PERA model, the IT portion 102 represents levels four and five, the gateway device 108 represents level three, and the OT portion 110 represents levels zero, one, and two.

In some implementations, the network 100 includes one or more device groups 105 (e.g., 105-1, 105-2, . . . 105-m). Each device group 105 includes one or more user devices 104. In the example shown in FIG. 1, the first device group 105-1 includes one user device 104-1; the second device group 105-2 includes three user devices 104-2, 104-3, and 104-4; and the mth device group 105-m includes a plurality of user devices, including at least user devices 104-5 and 104-n).

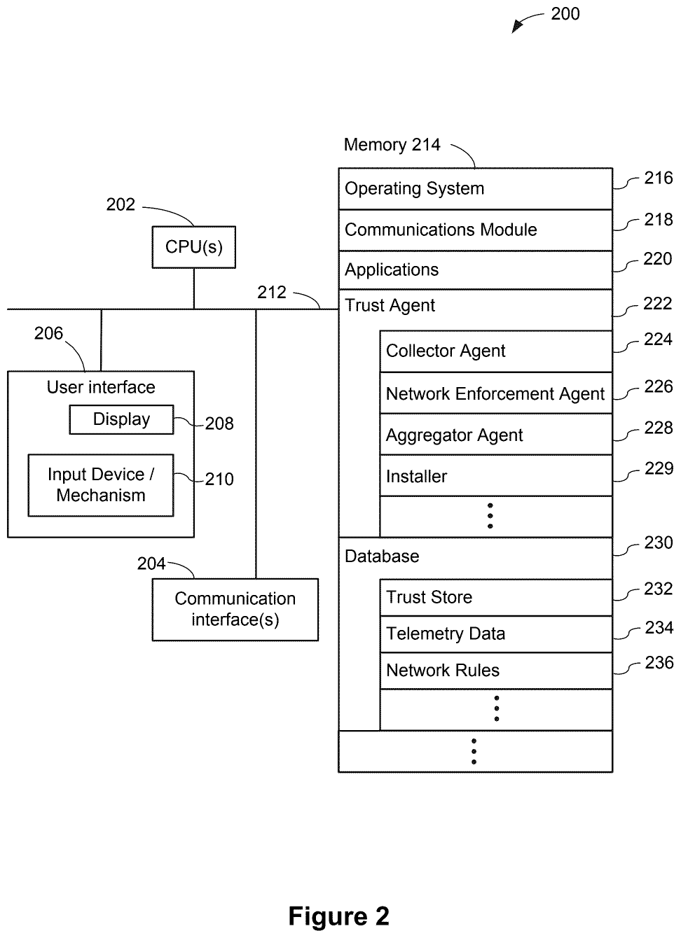

FIG. 2 is a block diagram of a computing device 200 (also referred to as computing system, user device, personal computing device, or personal device) in accordance with some implementations. Various examples of the computing device 200 (corresponding to user device 104) include a desktop computer, a laptop computer, a tablet computer, and other computing devices (e.g., IT or OT devices) that have a processor capable of running a trust agent 222. The computing device 200 typically includes one or more processing units/cores (CPUs) 202 for executing modules, programs, and/or instructions stored in the memory 214 and thereby performing processing operations; one or more network or other communications interfaces 204; memory 214; and one or more communication buses 212 for interconnecting these components. The communication buses 212 may include circuitry that interconnects and controls communications between system components.

In some implementations, the computing device 200 includes a user interface 206 comprising a display device 208 and one or more input devices or mechanisms 210. In some implementations, the input device/mechanism includes a keyboard. In some implementations, the input device/mechanism includes a “soft” keyboard, which is displayed as needed on the display device 208, enabling a user to “press keys” that appear on the display 208. In some implementations, the display 208 and input device/mechanism 210 comprise a touch screen display (also called a touch sensitive display).

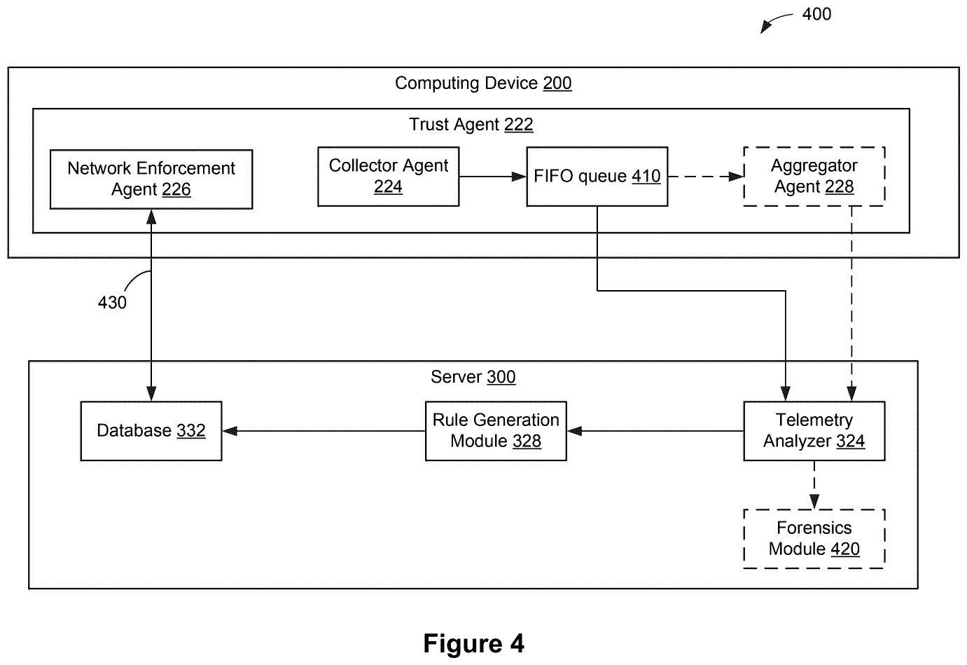

In some implementations, the memory 214 includes high-speed random-access memory, such as DRAM, SRAM, DDR RAM or other random-access solid-state memory devices. In some implementations, the memory 214 includes non-volatile memory, such as one or more magnetic disk storage devices, optical disk storage devices, flash memory devices, or other non-volatile solid state storage devices. In some implementations, the memory 214 includes one or more storage devices remotely located from the CPU(s) 202. The memory 214, or alternatively the non-volatile memory device(s) within the memory 214, comprises a non-transitory computer-readable storage medium. In some implementations, the memory 214, or the computer-readable storage medium of the memory 214, stores the following programs, modules, and data structures, or a subset thereof:
an operating system 216, which includes procedures for handling various basic system services and for performing hardware dependent tasks;
a communications module 218, which is used for connecting the computing device 200 to other computers and devices via the one or more communication network interfaces 204 (wired or wireless) and one or more communication networks, such as the Internet, other wide area networks, local area networks, metropolitan area networks, and so on;
applications 220, which perform particular tasks or sets of tasks for a user (e.g., word processors, media players, web browsers, and communication platforms);
a trust agent 222, which protects the computing device 200 by monitoring system level operations and executing security controls as dictated by network rule configurations. The trust agent 222 includes one or more of:
   a collector agent 224, which is a collector thread that collects information regarding connections to and from the computing device 200. The collector agent 224 also inserts the collected information into a first-in first-out (FIFO) queue so that the collected information can be sent to a Trust Center (such as a Trust Center located at a hub device 106);
   a network enforcement agent 226, which allows or blocks network connections to the computing device 200 based on network rules;
   an aggregator agent 228, which aggregates the collected telemetry data and deduplicates the data prior to transmitting the telemetry data to a Trust Center associated with the network on which the computing device 200 is running; and
   an installer 229, which identifies executable files and installs trust agent components. In some implementations, the installer 229 is only obtainable from a trust center. In some implementations, the installer 229 is available for download from the trust center via a web browser. In some implementations, the installer 229 customizes installation of the trust agent components (e.g., based on device type, operating system, and administrator settings); and
one or more databases 230, which are used by the applications 220 and/or the trust agent 222. The one or more databases 230, including the trust store 232, are described in more detail with reference to FIGS. 1 and 4. In some implementations, the one or more databases 230 also include telemetry data 234 for the computing device 200 (collected by the collector agent 224) and network rules 236, which instruct the network enforcement agent 226 on which connections to allow or deny for the computing device 200.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 214 stores a subset of the modules and data structures identified above. Furthermore, the memory 214 may store additional modules or data structures not described above.

Although FIG. 2 shows a computing device 200 (corresponding to user device 104), FIG. 2 is intended more as a functional description of the various features that may be present rather than as a structural schematic of the implementations described herein. In practice, and as recognized by those of ordinary skill in the art, items shown separately could be combined and some items could be separated.

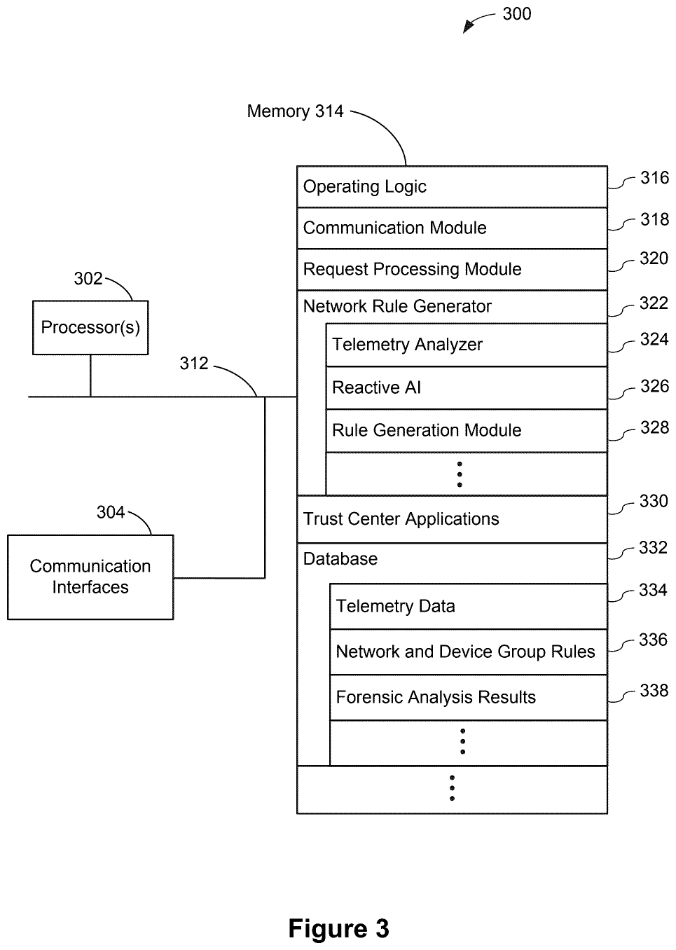

FIG. 3 is a block diagram illustrating a server 300 in accordance with some implementations. A server 300 may host one or more databases 332 or may provide various executable applications or modules. A server 300 typically includes one or more processing units/cores (CPUs) 302, one or more network interfaces 304, memory 314, and one or more communication buses 312 for interconnecting these components. In some implementations, the server 300 includes a user interface, which may include a display and one or more input devices, such as a keyboard and a mouse. In some implementations, the communication buses 312 include circuitry (sometimes called a chipset) that interconnects and controls communications between system components.

In some implementations, the memory 314 includes high-speed random-access memory, such as DRAM, SRAM, DDR RAM or other random-access solid-state memory devices. In some implementations, the memory 314 includes non-volatile memory, such as one or more magnetic disk storage devices, optical disk storage devices, flash memory devices, or other non-volatile solid state storage devices. In some implementations, the memory 314 includes one or more storage devices remotely located from the CPU(s) 302. The memory 314, or alternatively the non-volatile memory device(s) within the memory 314, comprises a non-transitory computer-readable storage medium. In some implementations, the memory 314, or the computer-readable storage medium of the memory 314, stores the following programs, modules, and data structures, or a subset thereof:
operating logic 316, which includes procedures for handling various basic system services and for performing hardware dependent tasks;
a communication module 318, which is used for connecting the server 300 to other computers and devices via the one or more communication network interfaces 304 (wired or wireless) and one or more communication networks, such as the Internet, other wide area networks, local area networks, metropolitan area networks, and so on;
a request processing module 320, which receives requests from computing devices and responds by providing network rules that apply to the computing devices;
a network rule generator 322, which generates one or more network rules based on telemetry data received from computing devices within the network. In some implementations, the network rule generator 322 generates rules for each device group in the network. In some implementations, the network rule generator 322 updates existing rules with newly generated rules and transmits the updated rules to computing devices on the network. In some implementations, the network rule generator 322 includes various software modules to perform certain tasks. In some implementations, the network rule generator 322 includes a graphical user interface module, which provides the user interface for all aspects of the network rule generator 322. The network rule generator 322 includes one or more of:
   a telemetry analyzer 324, which analyzes telemetry data received from computing devices within the network (e.g., network 100);
   reactive artificial intelligence (AI) 326, which includes one or more AI machines. There are four main types of AI machines. The first type of AI machine includes reactive machines, which perform basic operations. This may be the simplest form of AI. This type takes in some input and reacts with some output. This type does not store any input and does not participate in learning. The second type of AI machine includes limited memory machines that perform operations based on previously stored data or predictions, and use that data to make better predictions. With limited memory, machine learning becomes a bit more complex because each machine learning model requires limited memory to be allocated, but the model can be deployed as a reactive machine. The third type of AI machine includes theory of mind AI machines, which interact with the thoughts and emotions of humans. The fourth type of AI machine includes self-aware machines. In some implementations, a countermeasure is a reactive artificial intelligence machine. The reactive AI 326 may include any of the 4 types of AI machines; and
   a rule generation module 328, which generates one or more new rules and/or updates existing rules based on analysis of the telemetry data;
trust center applications 330, which include applications executed at the Trust Center. For example, the trust center applications 330 may include one or more applications required to effectively manage trust agents 222 that are installed on computing devices within the network (e.g., network 100); and
one or more databases 332, which store data used or created by the network rule generator 322 and other trust center applications 330. The databases 332 may store telemetry data 334, network and device group rules 336, and forensic analysis results 338 as described above. In some implementations, the telemetry data 334 includes the telemetry data 234 from computing devices (e.g., multiple computing devices) that are on the network (e.g., network 100).

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 314 stores a subset of the modules and data structures identified above. Furthermore, the memory 314 may store additional modules or data structures not described above.

Although FIG. 3 shows a server 300, FIG. 3 is intended more as a functional description of the various features that may be present rather than as a structural schematic of the implementations described herein. In practice, and as recognized by those of ordinary skill in the art, items shown separately could be combined and some items could be separated. Additionally, some of the programs, functions, procedures, or data shown above with respect to a server 300 may be stored or executed on a computing device 200. In some implementations, the functionality and/or data may be allocated between a computing device 200 and one or more servers 300. Furthermore, one of skill in the art recognizes that FIG. 3 need not represent a single physical device. In some implementations, the server functionality is allocated across multiple physical devices that comprise a server system. As used herein, references to a “server” include various groups, collections, or arrays of servers that provide the described functionality, and the physical servers need not be physically collocated (e.g., the individual physical devices could be spread throughout the United States or throughout the world).

FIG. 4 illustrates a process 400 of automatic rule generation and rule implementation in accordance with some implementations. In some implementations, a computing device 200 (corresponding to a user device 104, shown in FIG. 1), includes a trust agent 222 that includes a network enforcement agent 226, a collector agent 224, a first-in-first-out (FIFO) queue 410, and, in some implementations, an aggregator agent 228. The computing device 200 is part of a network (e.g., network 100) that is associated with a server 300 (corresponding to the hub 106 and/or the Trust Center for the network 100). In some implementations, the network 100 includes a plurality of devices (e.g., computing devices 200 or user devices 104). In some implementations, the network includes a plurality of device groups 105, and each device group includes a unique (e.g., separate or distinct) and non-overlapping subset of the plurality of computing devices. In such cases, the server 300 manages the trust agent 222 in each device of the plurality of devices that are part of the network. The portion of the process 400 performed at the computing device 200, described below, is performed at each of the computing devices within the network.

The process 400 begins at the computing device 200. The collector agent 224 collects telemetry data 234 for the computing device 200. The telemetry data includes information regarding connections to and from the computing device 200, including, but not limited to: an IP address associated with the connection, a port associated with the connection (e.g., port used for the connection), a protocol associated with the connection (e.g., IP address, NetMask, Type-TCP or UDP), a TrustID of a process associated with the connection, or a connection direction (e.g., outbound connection or inbound connection) of the connection. The data is then transmitted (e.g., forwarded) to the FIFO queue 410 before being transmitted to a telemetry analyzer 324 at the server 300. In some implementations, the telemetry data is collected and transmitted to the FIFO queue 410 at a predetermined time interval (e.g., every 2 seconds or every 30 seconds) that can be configured for each device group within the network 100. For example, devices of a first device group may be configured to collect and transmit the telemetry data to a FIFO queue every 1 second, whereas devices of a second device group may be configured to collect and transmit the telemetry data to a FIFO queue every 5 seconds.

In some implementations, the telemetry data is aggregated by the aggregator agent 228 prior to being transmitted to the server 300. In some implementations, aggregating the telemetry data includes deduplicating the telemetry data. In some implementations, the telemetry data is stored in a database 230 of the computing device 200. In some implementations, the telemetry data is aggregated at a predefined time interval (e.g., every 30 minutes or every 3 hours). In some implementations, the telemetry data is transmitted to the server 300 at a predefined time period (e.g., every hour or every 12 hours).

The telemetry analyzer 324 analyzes the telemetry data and transmits the analysis results to the rule generation module 328. In some implementations, the telemetry analyzer 324 utilizes reactive AI 326 to analyze the telemetry data. The rule generation module 328 utilizes the telemetry data analysis results to generate network rules for the network 100. In the case where the network includes multiple device groups (e.g., network 100 includes device groups 105-1, 105-2, . . . 150-m as shown in FIG. 1), the network rules include device group rules that are unique to each device group (e.g., each device group has its own set of rules), and the device group rules are generated using analysis results from telemetry data obtained from devices belonging to the device group. For example, the rule generation module 328 generates rules for the first device group based on analysis of telemetry data obtained from devices belonging to the first device group. Similarly, the rule generation module 328 generates rules for the second device group based on analysis of telemetry data obtained from devices belonging to the second device group.

Any existing network rules (including device group rules) are updated based on the newly generated rules. Updating existing network rules may include merging and/or replacing existing network rules with the newly generated rules. The updated rules undergo an approval process before being stored in the server's database 332. In some implementations, the approval process is configured by an administrator of the network. In some implementations, the network administrator can include additional rules (e.g., in addition to the network rules that were automatically generated at the server 300) to allow or block specific connections. Once approved, the updated network rules are stored in the server's database 332. The updated network rules are transmitted to the network enforcement agent 226, which is part of the trust agent 222. In some implementations, the computing device 200 and the server 300 are in communication with one another and form a full-duplex point-to-point communication system. This periodic communication includes the transfer of information back and forth between the computing device 200 and the server 300 and is also sometimes referred to as a heartbeat 430. In some implementations, the updated network rules are transmitted to computing device 200 as part of the heartbeat 430. In some implementations, the heartbeat 430 is configured to transmit data between the computing device 200 and the server 300 at a predetermined time interval (e.g., every 10 seconds or every 60 minutes).

In some implementations, the predetermined time interval for the heartbeat 430, the predetermined time interval for the aggregation of telemetry data, and the predetermined time interval for the transmission of telemetry data from the computing device 200 to the server 300 are separate from one another and can be configured separately to have any time interval. For example, the predetermined time interval for the heartbeat 430 between the computing device 200 and the server 300 may be 10 minutes, the time interval for the aggregation of telemetry data may be 30 seconds, and the predetermined time interval for the transmission of telemetry data from the computing device 200 to the server 300 may be 60 minutes. Each of these time intervals can be configured for a device group so that all devices within the same device group share the same respective time intervals for each of these actions. For example, all devices of the first device group are connected to the server 300 via a heartbeat 430 that transmits data every 5 minutes, aggregates telemetry data every 15 seconds, and transmits the aggregated telemetry data to the server 300 every 20 minutes. Similarly, all devices of the second device group are connected to the server 300 via a heartbeat 430 that transmits data every 42 minutes, aggregates telemetry data every 19 seconds, and transmits the aggregated telemetry data to the server 300 every 40 minutes.

In some implementations, the telemetry data 334 (e.g., telemetry data for all devices in the network) and/or the analysis results are transmitted to a forensics module 420 for forensics analysis. The forensics analysis may include, for example, a record and analysis of saved network rules (including device group rules).

In some implementations, the network rules for the first device group are different from the network rules for the second device group. For example, the network rules for the first device group may include:
allow connections to a first address and a second address;
block connections to a third address; and
block connections to any unknown addresses.

Following the example above, the network rules for the second device group may include:
allow connections to the first address;
block connections to the second address; and
block connections to any unknown addresses.

In some implementations, as shown in the example provided above, network rules for a first device group and network rules for another device group (e.g., second device group) may have one or more rules in common (e.g., are the same). In some implementations, network rules for a first device group may include one or more rules that are not included in the network rules for another device group (e.g., second device group). In some implementations, the rules for a first device group may include one or more rules that are different from the network rules for another device group (e.g., second device group).

In some implementations, the forensics analysis can be used to improve security for the network.

In a first example, a first computing device 104-1 that belongs to a first device group 105-1 attempts to connect to an unknown address. The network rules for the first device group includes blocking any unknown addresses. Thus, the connection from the first computing device to the unknown address is blocked.

In a second example, a new device is added to the network 100. The network has a new device policy that is configured (e.g., determined or dictated) by an administrator. For this example, the new device policy for the network is to automatically assign new devices to a default device group. In this example, the new device is automatically assigned to the default device group, and network rules for the default device group are transmitted to the new device and enforced by a trust agent 222 operating on the new device. The new device remains in the default device group until an administrator of the network moves the new device to a different device group. For example, the new device may be part of the default device group during setup, and once the new device has been assigned to a user (e.g., on the sales team), the administrator assigns the new device to a new device group (e.g., the sales team device group). In response to the new device being removed from the default device group and assigned to the new device group, the network rules for the new device group are transmitted to the new device and enforced by the trust agent operating on the new device.

In a third example, a trust agent 222 operating at a computing device 104-1 that is part of the network 100 determines that the computing device has excessive computer processing unit (CPU) utilization and may be under a distributed denial-of-service (DDoS) attack. In response to this determination, the trust agent automatically puts the computing device under quarantine, such that only connections to the Trust Center are allowed on the computing device, and all other connections are blocked. The computing device can be moved out of quarantine by an administrator.

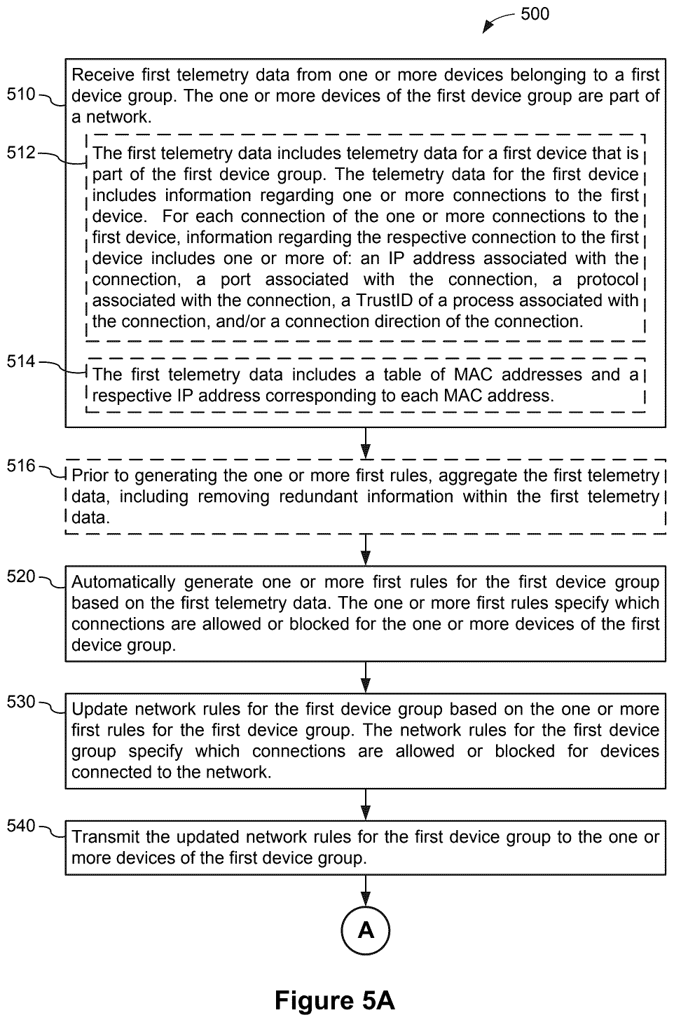

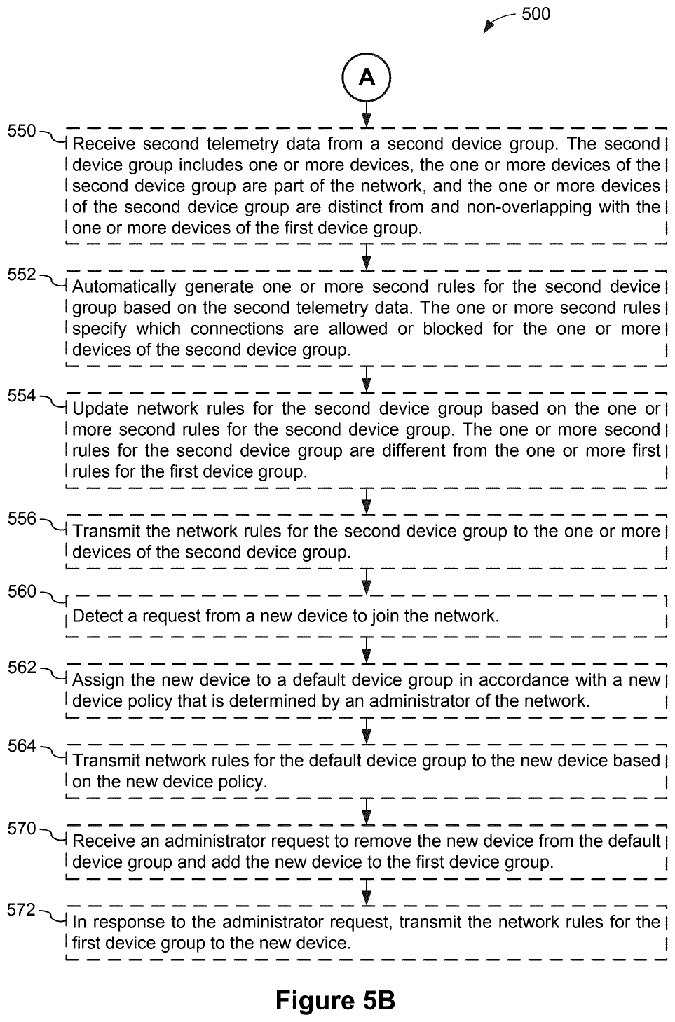

FIGS. 5A and 5B provide a flowchart of a method 500 for automatically generating network rules in accordance with some implementations. The method 500 is performed at a server (e.g., the server 300, the hub 106, or the Trust Center) having one or more processors and memory. In some implementations, the memory stores one or more programs configured for execution by the one or more processors. The method 500 includes receiving (step 510) first telemetry data 234 from one or more devices of a first device group (e.g., the user device 104-1 in the device group 105-1, as shown in FIG. 1). The one or more devices of the first device group are part of a network 100. The method 500 also includes automatically generating (step 520) one or more first rules for the first device group based on the first telemetry data (e.g., the telemetry data obtained from device 104-1 that is part of the first device group 105-1). The one or more first rules specify which connections are allowed or blocked for the one or more devices of the first device group. The method 500 further includes updating (step 530) network rules for the first device group based on the one or more first rules for the first device group. The network rules for the first device group specify which connections are allowed or blocked for the one or more devices that are part of the first device group and connected to the network. The method 500 also includes transmitting (step 540) the updated network rules for the first device group to the one or more devices of the first device group.

In some implementations, the first telemetry data includes (step 512) telemetry data for a first device that is part of the first device group. The telemetry data for the first device (e.g., the telemetry data 234 for the first user device 104-1) includes information regarding one or more connections to the first device. For each connection of the one or more connections to the first device, information regarding the respective connection to the first device includes one or more of: an IP address associated with the connection, a port associated with the connection, a protocol associated with the connection, a TrustID of a process associated with the connection, and/or a connection direction (e.g., outbound or inbound) of the connection.

In some implementations, the first telemetry data includes (step 514) a table of MAC addresses and a respective IP address corresponding to each MAC address.

In some implementations, the method 500 further includes, prior to generating the one or more first rules, aggregating (step 516) the first telemetry data, including removing redundant information within the first telemetry data.

In some implementations, the method 500 further includes receiving (step 550) second telemetry data from a second device group (e.g., the device group 105-2 shown in FIG. 1). The second device group includes one or more devices (e.g., the devices 104-2, 104-3, and 104-4 shown in FIG. 1). The one or more devices of the second device group are part of the network 100. The one or more devices of the second device group are distinct from and non-overlapping with the one or more devices of the first device group. The method 500 also includes automatically generating (step 552) one or more second rules for the second device group based on the second telemetry data. The one or more second rules specify which connections are allowed or blocked for the one or more devices of the second device group. The method 500 further includes updating (step 554) network rules for the second device group based on the one or more second rules for the second device group. The one or more second rules for the second device group are different from the one or more first rules for the first device group. The method 500 also includes transmitting (step 556) the network rules for the second device group to the one or more devices of the second device group.

In some implementations, the method 500 further includes detecting (step 560) a request from a new device to join the network 100, assigning (step 562) the new device to a default device group in accordance with a new device policy that is determined by an administrator of the network, and transmitting (step 564) network rules for the default device group to the new device based on the new device policy. In some implementations, the new device policy for the network is determined (e.g., defined or configured) by an administrator of the network. In some implementations, the new device policy for the network is manually determined (e.g., defined or configured) by a human administrator of the network.

In some implementations, the method 500 further includes receiving (step 570) an administrator request to remove the new device from the default device group and add the new device to the first device group. In response to the administrator request, the method transmits (step 572) the network rules for the first device group to the new device.

In some implementations, the automatically generated rules are expressed in Backus-Naur form (also referred to as Backus normal form or BNF).

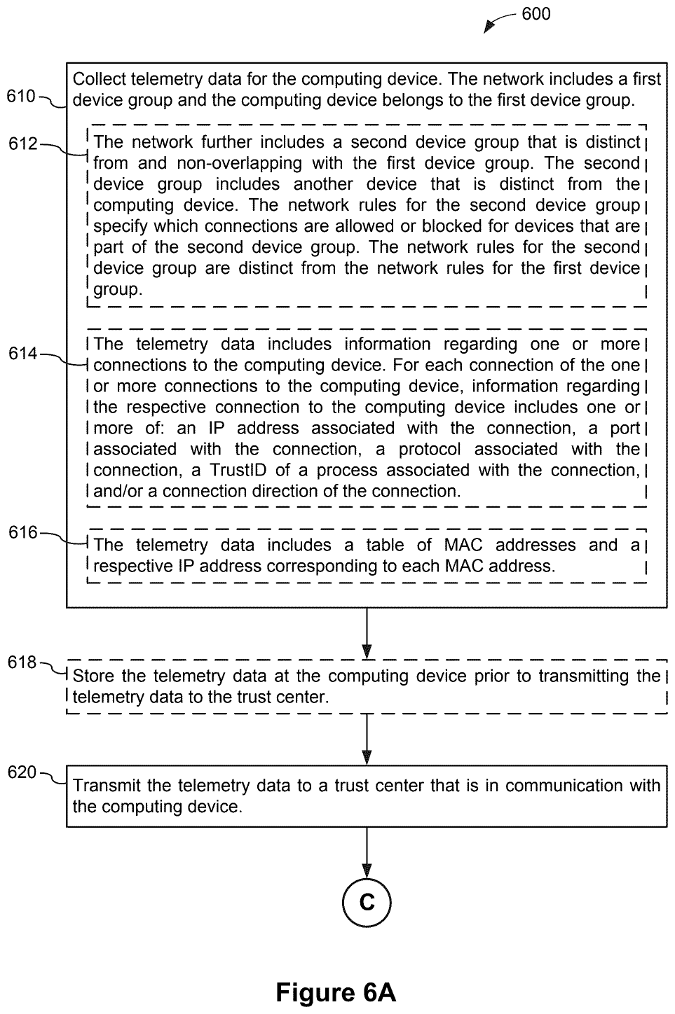

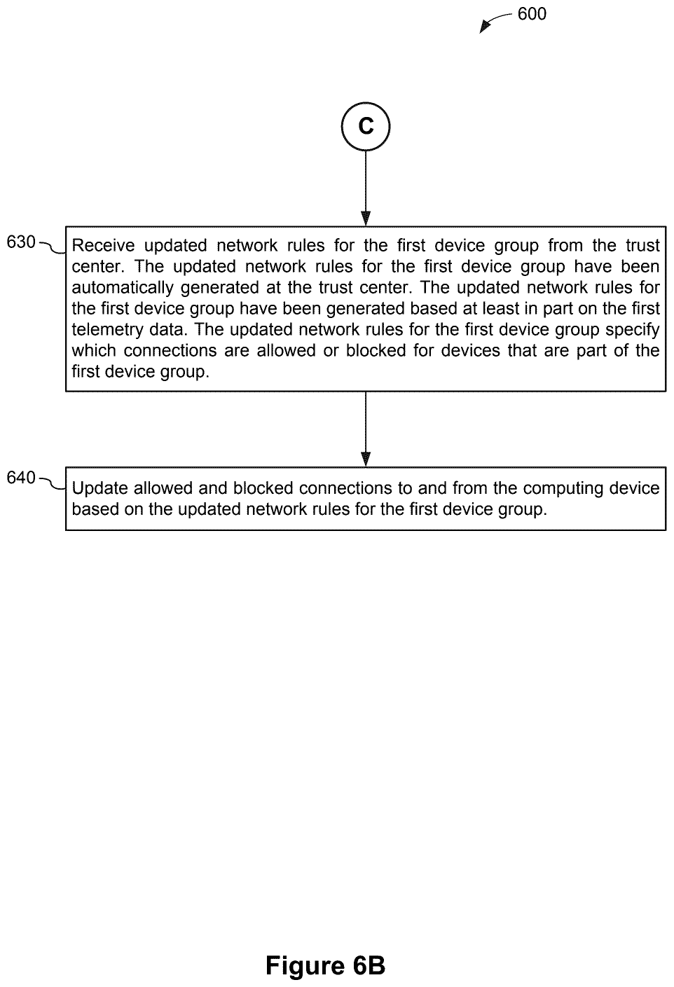

FIGS. 6A and 6B provide a flowchart of a method 600 performed at a computing device 200 (corresponding to user devices 104 shown in FIG. 1) that is part of a network 100 in accordance with some implementations. The method 600 is performed at a computing system (e.g., the computing device 200 shown in FIG. 2, or the user device 104 shown in FIG. 1) having one or more processors and memory. In some implementations, the memory stores one or more programs configured for execution by the one or more processors.

The method 600 includes collecting (step 610) telemetry data 234 for the computing device. The network includes a first device group, and the computing device belongs to the first device group (e.g., the first device 104-1 is part of the first device group 105-1). The method 600 also includes transmitting (step 620) the telemetry data 234 to a trust center (e.g., the server 300 shown in FIG. 4 or the hub 106 shown in FIG. 1) that is in communication with the computing device. The method 600 further includes receiving (step 630) updated network rules for the first device group from the trust center. The updated network rules for the first device group have been automatically generated at the trust center. The updated network rules for the first device group have been generated based, at least in part, on the first telemetry data 234. The updated network rules for the first device group specify which connections are allowed or blocked for devices that are part of the first device group. The method 600 also includes updating (step 640) allowed and blocked (e.g., disabled) connections to and from the computing device based on the updated network rules for the first device group.

In some implementations, the network further includes (step 612) a second device group that is distinct from and non-overlapping with the first device group (e.g., the second device group 105-2 is distinct from the first device group 105-1). The second device group includes another device (e.g., the second user device 104-2), which is distinct from the computing device (e.g., the first user device 104-1). The network rules for the second device group specify which connections are allowed or blocked for devices that are part of the second device group. The network rules for the second device group are distinct from the network rules for the first device group.

In some implementations, the telemetry data 234 includes (step 614) information regarding one or more connections to the computing device. For each connection of the one or more connections to the computing device, information regarding the respective connection to the computing device includes an IP address associated with the connection, a port associated with the connection, a protocol associated with the connection, a TrustID of a process associated with the connection, and/or a connection direction (e.g., inbound or outbound) of the connection.

In some implementations, the telemetry data 234 includes (step 616) a table of MAC addresses and a respective IP address corresponding to each MAC address.

In some implementations, the system stores (618) the telemetry data at the computing device prior to transmitting the telemetry data to the trust center.

Turning now to some example implementations.

(A1) In one aspect, some implementations include a method (e.g., the method 500) for automatically generating network rules. The method includes receiving first telemetry data from one or more devices belonging to a first device group. The one or more devices of the first device group are part of a network. The method also includes automatically generating one or more first rules for the first device group based on the first telemetry data. The one or more first rules specify which connections are allowed or blocked for the one or more devices of the first device group. The method further includes updating network rules for the first device group based on the one or more first rules for the first device group. The network rules for the first device group specify which connections are allowed or blocked for the one or more devices that are part of the first device group and connected to the network. The method also includes transmitting the updated network rules for the first device group to the one or more devices of the first device group.

(A2) The method of A1, further including receiving second telemetry data from a second device group. The second device group includes one or more devices, the one or more devices of the second device group are part of the network, and the one or more devices of the second device group are distinct from and non-overlapping with the one or more devices of the first device group. The method also includes automatically generating one or more second rules for the second device group based on the second telemetry data. The one or more second rules specify which connections are allowed or blocked for the one or more devices of the second device group. The method further includes updating network rules for the second device group based on the one or more second rules for the second device group. The one or more second rules for the second device group are different from the one or more first rules for the first device group. The method also includes transmitting the network rules for the second device group to the one or more devices of the second device group.

(A3) The method of A1 or A2, where the first telemetry data includes telemetry data for a first device that is part of the first device group and the telemetry data for the first device includes information regarding one or more connections to the first device. For each connection of the one or more connections to the first device, information regarding the respective connection to the first device includes an IP address associated with the connection, a port associated with the connection, a protocol associated with the connection, a TrustID of a process associated with the connection, and/or a connection direction of the connection.

(A4) The method of any of A1 - A3, where the first telemetry data includes a table of MAC addresses and a respective IP address corresponding to each MAC address.

(A5) The method of any of A1 - A4, where the method includes, prior to generating the one or more first rules, aggregating the first telemetry data, including removing redundant information within the first telemetry data.

(A6) The method of any of A1 - A5, where the method further includes detecting a request from a new device to join the network and assigning the new device to a default device group in accordance with a new device policy that is determined by an administrator of the network. The method also includes transmitting network rules for the default device group to the new device based on the new device policy.

(A7) The method of A6, where the method further includes receiving an administrator request to remove the new device from the default device group and to add the new device to the first device group. In response to the administrator request, the method transmits the network rules for the first device group to the new device.

(B1) In another aspect, some implementations include a method that is performed at a computing device that is part of a network. The method includes collecting telemetry data for the computing device. The network includes a first device group, and the computing device belongs to the first device group. The method also includes transmitting the telemetry data to a trust center that is in communication with the computing device and receiving updated network rules for the first device group from the trust center. The updated network rules for the first device group have been automatically generated at the trust center, the updated network rules for the first device group have been generated based, at least in part, on the first telemetry data, and the updated network rules for the first device group specify which connections are allowed or blocked for devices that are part of the first device group. The method further includes updating allowed and blocked (e.g., disabled) connections to and from the computing device based on the updated network rules for the first device group.

(B2) The method of B1, where the method further includes storing the telemetry data at the computing device prior to transmitting the telemetry data to the trust center.

(B3) The method of B1 or B2, where the network further includes a second device group that is distinct from and non-overlapping with the first device group, the second device group includes another device that is distinct from the computing device, network rules for the second device group specify which connections are allowed or blocked for devices that are part of the second device group, and the network rules for the second device group are distinct from the network rules for the first device group.

(B4) The method of any of B1-B3, where the telemetry data includes information regarding one or more connections to the computing device. For each connection of the one or more connections to the computing device, information regarding the respective connection to the computing device includes an IP address associated with the connection, a port associated with the connection, a protocol associated with the connection, a TrustID of a process associated with the connection, and/or a connection direction of the connection

(B5) The method of any of B1-B4, where the telemetry data includes a table of MAC addresses and a respective IP address corresponding to each MAC address.

In another aspect, some implementations include a computing system having one or more processors and memory coupled to the one or more processors. The memory stores one or more programs configured to be executed by the one or more processors. The one or more programs include instructions for performing any of the methods described herein (e.g., A1-A7 and B1-B5 above).

In yet another aspect, some implementations include a non-transitory computer-readable storage medium storing one or more programs configured for execution by one or more processors of a computing system. The one or more programs include instructions for performing any of the methods described herein (e.g., A1-A7 and B1-B5 above).

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A method, performed at a computing device having one or more processors and memory, the method comprising:
receiving first telemetry data from one or more devices belonging to a first device group, wherein the one or more devices of the first device group are part of a network;
automatically generating one or more first rules for the first device group based on the first telemetry data, wherein the one or more first rules specify which connections are allowed or blocked for the one or more devices of the first device group;
updating network rules for the first device group based on the one or more first rules for the first device group, wherein the network rules for the first device group specify which connections are allowed or blocked for the one or more devices that are part of the first device group and connected to the network; and
transmitting the updated network rules for the first device group to the one or more devices of the first device group.

2. The method of claim 1, further comprising:
receiving second telemetry data from a second device group, wherein:
the second device group includes one or more devices;
the one or more devices of the second device group are part of the network; and
the one or more devices of the second device group are distinct from and non-overlapping with the one or more devices of the first device group;
automatically generating one or more second rules for the second device group based on the second telemetry data, wherein the one or more second rules specify which connections are allowed or blocked for the one or more devices of the second device group;
updating network rules for the second device group based on the one or more second rules for the second device group, wherein the one or more second rules for the second device group are different from the one or more first rules for the first device group; and
transmitting the network rules for the second device group to the one or more devices of the second device group.

3. The method of claim 1, wherein:
the first telemetry data includes telemetry data for a first device that is part of the first device group;
the telemetry data for the first device includes information regarding one or more connections to the first device; and
for each connection of the one or more connections to the first device, information regarding the respective connection to the first device includes an IP address associated with the respective connection, a port associated with the respective connection, a protocol associated with the respective connection, a TrustID of a process associated with the respective connection, and/or a connection direction of the respective connection.

4. The method of claim 1, wherein the first telemetry data includes a table of MAC addresses and a respective IP address corresponding to each MAC address.

5. The method of claim 1, further comprising:
prior to generating the one or more first rules, aggregating the first telemetry data, including removing redundant information within the first telemetry data.

6. The method of claim 1, further comprising:
detecting a request from a new device to join the network;
assigning the new device to a default device group in accordance with a new device policy that is determined by an administrator of the network; and
transmitting network rules for the default device group to the new device based on the new device policy.

7. The method of claim 6, further comprising:
receiving an administrator request to remove the new device from the default device group and to add the new device to the first device group; and
in response to the administrator request, transmitting the network rules for the first device group to the new device.

8. A computing device, comprising:
one or more processors;
memory; and
one or more programs stored in the memory and configured for execution by the one or more processors, the one or more programs comprising instructions for:
receiving first telemetry data from one or more devices belonging to a first device group, wherein the one or more devices of the first device group are part of a network;
automatically generating one or more first rules for the first device group based on the first telemetry data, wherein the one or more first rules specify which connections are allowed or blocked for the one or more devices of the first device group;
updating network rules for the first device group based on the one or more first rules for the first device group, wherein the network rules for the first device group specify which connections are allowed or blocked for devices connected to the network; and
transmitting the updated network rules for the first device group to the one or more devices of the first device group.

9. The computing device of claim 8, wherein the one or more programs further comprise instructions for:
receiving second telemetry data from a second device group, wherein:
the second device group includes one or more devices;
the one or more devices of the second device group are part of the network; and
the one or more devices of the second device group are distinct from and non-overlapping with the one or more devices of the first device group;
automatically generating one or more second rules for the second device group based on the second telemetry data, wherein the one or more second rules specify which connections are allowed or blocked for the one or more devices of the second device group;
updating network rules for the second device group based on the one or more second rules for the second device group, wherein the one or more second rules for the second device group are different from the one or more first rules for the first device group; and
transmitting the network rules for the second device group to the one or more devices of the second device group.

10. The computing device of claim 8, wherein:
the first telemetry data includes telemetry data for a first device that is part of the first device group;
the telemetry data for the first device includes information regarding one or more connections to the first device; and
for each connection of the one or more connections to the first device, information regarding the respective connection to the first device includes an IP address associated with the respective connection, a port associated with the respective connection, a protocol associated with the respective connection, a TrustID of a process associated with the respective connection, and/or a connection direction of the respective connection.

11. The computing device of claim 8, wherein the first telemetry data includes a table of MAC addresses and a respective IP address corresponding to each MAC address.

12. The computing device of claim 8, wherein the one or more programs further comprise instructions for:
prior to generating the one or more first rules, aggregating the first telemetry data, including removing redundant information within the first telemetry data.

13. The computing device of claim 8, further comprising:
detecting a request from a new device to join the network;
assigning the new device to a default device group in accordance with a new device policy that is determined by an administrator of the network; and
transmitting network rules for the default device group to the new device based on the new device policy.

14. The computing device of claim 13, further comprising:
receiving an administrator request to remove the new device from the default device group and to add the new device to the first device group; and
in response to the administrator request, transmitting the network rules for the first device group to the new device.

15. A non-transitory computer-readable storage medium storing one or more programs configured for execution by a computing device having one or more processors and memory, the one or more programs comprising instructions for:
receiving first telemetry data from one or more devices belonging to a first device group, wherein the one or more devices of the first device group are part of a network;
automatically generating one or more first rules for the first device group based on the first telemetry data, wherein the one or more first rules specify which connections are allowed or blocked for the one or more devices of the first device group;
updating network rules for the first device group based on the one or more first rules for the first device group, wherein the network rules for the first device group specify which connections are allowed or blocked for devices connected to the network; and
transmitting the updated network rules for the first device group to the one or more devices of the first device group.

16. The non-transitory computer-readable storage medium of claim 15, wherein the one or more programs further comprise instructions for:
receiving second telemetry data from a second device group, wherein:
the second device group includes one or more devices;
the one or more devices of the second device group are part of the network; and
the one or more devices of the second device group are distinct from and non-overlapping with the one or more devices of the first device group;
automatically generating one or more second rules for the second device group based on the second telemetry data, wherein the one or more second rules specify which connections are allowed or blocked for the one or more devices of the second device group;
updating network rules for the second device group based on the one or more second rules for the second device group, wherein the one or more second rules for the second device group are different from the one or more first rules for the first device group; and
transmitting the network rules for the second device group to the one or more devices of the second device group.

17. The non-transitory computer-readable storage medium of claim 15, wherein:
the first telemetry data includes telemetry data for a first device that is part of the first device group;
the telemetry data for the first device includes information regarding one or more connections to the first device; and
for each connection of the one or more connections to the first device, information regarding the respective connection to the first device includes an IP address associated with the respective connection, a port associated with the respective connection, a protocol associated with the respective connection, a TrustID of a process associated with the respective connection, and/or a connection direction of the respective connection.

18. The non-transitory computer-readable storage medium of claim 15, wherein the first telemetry data includes a table of MAC addresses and a respective IP address corresponding to each MAC address.

19. The non-transitory computer-readable storage medium of claim 15, wherein the one or more programs further comprise instructions for:
prior to generating the one or more first rules, aggregating the first telemetry data, including removing redundant information within the first telemetry data.

20. The non-transitory computer-readable storage medium of claim 15, wherein the one or more programs further comprise instructions for:
detecting a request from a new device to join the network;
assigning the new device to a default device group in accordance with a new device policy that is determined by an administrator of the network;
transmitting network rules for the default device group to the new device based on the new device policy;
receiving an administrator request to remove the new device from the default device group and to add the new device to the first device group; and
in response to the administrator request, transmitting the network rules for the first device group to the new device.
